(19) United States
(12) Patent Application Publication
(10) Pub. No.: US 2025/0005906 A1
(43) Pub. Date: Jan. 2, 2025

(54) OBJECT DETECTION NETWORKS FOR DISTANT OBJECT DETECTION IN MEMORY-CONSTRAINED DEVICES

(71) Applicant: Synaptics Incorporated, San Jose, CA (US)

(72) Inventors: Karthikeyan SHANMUGA VADIVEL, San Jose, CA (US); Patrick A. WORFOLK, Los Gatos, CA (US); Zacchaeus SCHEFFER, San Jose, CA (US); Dmitri LVOV, Ramat Hasharon (IL)

(73) Assignee: Synaptics Incorporated, San Jose, CA (US)

(21) Appl. No.: 18/344,064

(22) Filed: Jun. 29, 2023

(51) Int. Cl. G06V 10/77; G06V 10/22; G06V 10/26; G06V 10/764; G06V 10/766; G06V 10/82

(52) U.S. Cl. CPC G06V 10/7715; G06V 10/22; G06V 10/267; G06V 10/764; G06V 10/766; G06V 10/82

(57) ABSTRACT

This disclosure provides methods, devices, and systems for object detection. The present implementations more specifically relate to techniques for improving distant object detection in memory-constrained computer vision systems. In some aspects, a computer vision system may include an ROI extraction component, a feature pyramid network (FPN) having a number (N) of pyramid levels, and N network heads associated with the N pyramid levels, respectively. The FPN extracts N feature maps from an input image, where the N feature maps are associated with the N pyramid levels, respectively, and each of the N network heads performs an object detection operation on a respective feature map of the N feature maps. The ROI extraction component selects a region of the feature map associated with the lowest pyramid level for distant object detection so that the object detection operation performed on that feature map is confined to the selected region.

### TECHNICAL FIELD

The present implementations relate generally to object detection, and specifically to object detection networks for distant object detection in memory-constrained devices.

### BACKGROUND OF RELATED ART

Computer vision is a field of artificial intelligence (AI) that mimics the human visual system to draw inferences about an environment from images or video of the environment. Example computer vision technologies include object detection, object classification, and object tracking, among other examples. Object detection encompasses various techniques for detecting objects in the environment that belong to a known class (such as humans, cars, or text). For example, the presence and location of an object can be detected or inferred by scanning an image for a set of features (such as eyes, nose, and lips) that are unique to objects of a particular class (such as humans). Some object detection techniques rely on statistical models for feature extraction whereas other object detection techniques rely on neural network models for feature extraction. Such models can be used for localizing objects in images and may be generally referred to as “object detection models.”

The memory and processing resources required for object detection generally grows proportionally with the distance of the objects to be detected. For example, objects that are farther from the image capture device (such as a camera) appear smaller in captured images, with fewer or less-pronounced features. As such, high-resolution object detection models are often needed to detect distant objects in images. However, many high-resolution object detection models require substantial memory and processing resources to achieve accurate detection results. Because computer vision is often implemented by edge devices with limited resources (such as battery-powered cameras), there is a need to improve the accuracy of distant object detection without increasing the memory budget of object detection models.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented in a method of object detection. The method includes steps of receiving an input image; extracting a plurality of feature maps from the input image based on a feature pyramid network (FPN) having a plurality of pyramid levels, each feature map of the plurality of feature maps being associated with a respective pyramid level of the plurality of pyramid levels; selecting a region of a first feature map of the plurality of feature maps for distant object detection; and performing an object detection operation on each feature map of the plurality of feature maps based on a respective network head so that the object detection operation performed on the first feature map is confined to the selected region.

Another innovative aspect of the subject matter of this disclosure can be implemented in a method of object detection. The method includes steps of receiving an input image; selecting a region of the input image for distant object detection; extracting, from the selected region of the input image, a first feature map of a plurality of feature maps based on a backbone convolutional neural network (CNN); extracting, from the input image, one or more second feature maps of the plurality of feature maps based on an FPN having a plurality of pyramid levels, each feature map of the plurality of feature maps being associated with a respective pyramid level of the plurality of pyramid levels; and performing an object detection operation on each feature map of the plurality of feature maps based on a respective network head.

Another innovative aspect of the subject matter of this disclosure can be implemented in an object detection system including a processing system and a memory. The memory stores instructions that, when executed by the processing system, causes the object detection system to receive an input image; select a region of the input image for distant object detection; extract, from the selected region of the input image, a first feature map of a plurality of feature maps based on a backbone CNN; extract, from the input image, one or more second feature maps of the plurality of feature maps based on an FPN having a plurality of pyramid levels, each feature map of the plurality of feature maps being associated with a respective pyramid level of the plurality of pyramid levels; and perform an object detection operation on each feature map of the plurality of feature maps based on a respective network head.

### BRIEF DESCRIPTION OF THE DRAWINGS

The present embodiments are illustrated by way of example and are not intended to be limited by the figures of the accompanying drawings.

FIG. 1 shows a block diagram of an example computer vision system, according to some implementations.

FIG. 2A shows an example neural network operation that can be performed by a convolutional neural network (CNN).

FIG. 2B shows another example neural network operation that can be performed by a CNN.

FIG. 3 shows a block diagram of an example object detection network based on a feature pyramid network architecture.

FIG. 4 shows an example image that can be captured by a computer vision system.

FIG. 5 shows a block diagram of an example object detection network, according to some implementations.

FIG. 6 shows an example region of interest (ROI) that can be extracted from an example feature map.

FIG. 7 shows a block diagram of another example object detection network, according to some implementations.

FIG. 8 shows an example ROI that can be extracted from an example input image.

FIG. 9 shows a block diagram of an example object detection system, according to some implementations.

FIG. 10 shows a block diagram of another example object detection system, according to some implementations.

FIG. 11 shows an illustrative flowchart depicting an example object detection operation, according to some implementations.

FIG. 12 shows an illustrative flowchart depicting another example object detection operation, according to some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, object detection encompasses various techniques for detecting objects in images that belong to a known class. The memory and processing resources required for object detection generally grows proportionally with the distance of the objects to be detected. Specifically, high-resolution object detection models are often needed to detect distant objects in images. However, computer vision is often implemented in edge devices with limited memory and processing resources (such as battery-powered cameras). Aspects of the present disclosure recognize that such edge devices are often mounted to fixed locations (such as walls, televisions, or computer monitors) where distant objects are confined to a small region of interest (ROI) within the captured images. As such, the accuracy of distant object detection can be improved, without increasing the memory budget, by focusing high-resolution object detection models on the ROI in which distant objects are confined.

Various aspects relate generally to object detection, and more particularly, to improving the detection of distant objects by memory-constrained computer vision systems. In some aspects, a computer vision system may include an ROI extraction component, a feature pyramid network (FPN) having a number (N) of pyramid levels, and N network heads associated with the N pyramid levels, respectively. In such aspects, the FPN is configured to extract N feature maps from an input image, where the N feature maps are associated with the N pyramid levels, respectively, and each of the N network heads is configured to perform an object detection operation on a respective feature map of the N feature maps. In some implementations, the ROI extraction component may select a region of the feature map associated with the lowest pyramid level, of the N pyramid levels, for distant object detection. For example, the selected region may coincide with an ROI of the input image in which distant objects are confined. As a result, the object detection operation performed (by a respective network head) on the feature map associated with the lowest pyramid level is confined to the selected region.

In some other aspects, a computer vision system may include an ROI extraction component, a distant object backbone network, an FPN having a number (N) of pyramid levels, and N network heads associated with the N pyramid levels, respectively. In some implementations, the ROI extraction component may select a region of an input image for distant object detection. For example, the selected region may represent an ROI of the input image in which distant objects are confined. The distant object backbone network may extract a number (M) of feature maps from the selected region of the input image, where 1≤M<N and the M feature maps are associated with the M lowest pyramid levels of the N pyramid levels. The FPN is configured to extract an additional N-M feature maps from the input image (in its entirety), where the N-M feature maps are associated with the N-M remaining pyramid levels. Each of the N network heads is configured to perform an object detection operation on a respective feature map of the N feature maps (which includes the first feature map extracted by the distant object backbone network and the N-M feature maps extracted by the FPN).

Particular implementations of the subject matter described in this disclosure can be implemented to realize one or more of the following potential advantages. As described above, distant objects in an input image are often detected by high-resolution object detection models which are associated with the lowest pyramid levels of an FPN. By focusing the high-resolution object detection models on an ROI in which distant objects are confined, aspects of the present disclosure can improve the accuracy of distant object detection in memory-constrained edge devices. For example, by reducing the size of the feature map to be processed by the network head associated with the lowest pyramid level, aspects of the present disclosure can increase the number of neural network filters in the network head compared to existing computer vision systems with the same memory budget. Further, by reducing the size of the input image to be processed by a backbone network associated with the M lowest pyramid levels, aspects of the present disclosure can increase the number of neural network filters in the network backbone compared to existing computer vision systems with the same memory budget.

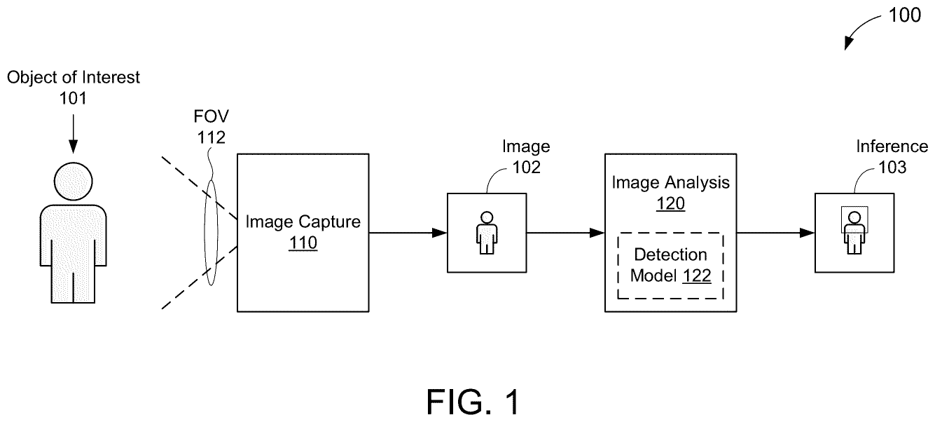

FIG. 1 shows a block diagram of an example computer vision system 100, according to some implementations. In some aspects, the computer vision system 100 may be configured to generate inferences about one or more objects of interest (also referred to as “target objects”). In the example of FIG. 1, an object of interest 101 is depicted as a person. In some other implementations, the computer vision system 100 may be configured to generate inferences about various other objects of interest in addition to, or in lieu of, the object of interest 101.

The system 100 includes an image capture component 110 and an image analysis component 120. The image capture component 110 may be any sensor or device (such as a camera) configured to capture a pattern of light in its field-of-view (FOV) 112 and convert the pattern of light to a digital image 102. For example, the digital image 102 may include an array of pixels (or pixel values) representing the pattern of light in the FOV 112 of the image capture component 110. In some implementations, the image capture component 110 may continuously (or periodically) capture a series of images 102 representing a digital video. As shown in FIG. 1, the object of interest 101 is located within the FOV 112 of the image capture component 110. As a result, the digital images 102 may include or depict the object of interest 101.

The image analysis component 120 is configured to produce one or more inferences 103 based on the digital image 102. In some aspects, the image analysis component 120 may infer whether one or more objects of interest 101 are depicted in the image 102. For example, the image analysis component 120 may detect the person in the digital image 102 and draw a bounding box around the person's face. In other words, the image analysis component 120 may produce an annotated image, as the inference 103, indicating the location of the object of interest 101 in relation to the image 102. In some aspects, the location of the object of interest 101 may change over time, for example, based on movements of the object of interest 101. Accordingly, the image analysis component 120 may produce different inferences 103 in response to images 102 captured at different times.

In some aspects, the image analysis component 120 may generate the inference 103 based on an object detection model 122. The object detection model 122 may be trained or otherwise configured to detect objects in images or video. For example, the object detection model 122 may apply one or more transformations to the pixels in the image 102 to create one or more features that can be used for object detection. More specifically, the object detection model 122 may compare the features extracted from the image 102 with a known set of features that uniquely identify a particular class of objects (such as humans) to determine a presence or location of any target objects in the image 102. In some implementations, the object detection model 122 may be a machine learning model.

Machine learning, which generally includes a training phase and an inferencing phase, is a technique for improving the ability of a computer system or application to perform a specific task. During the training phase, a machine learning system is provided with multiple “answers” and a large volume of raw input data. For example, the input data may include images depicting an object of interest and the answers may include bounding boxes indicating a presence and location of an object of interest. The machine learning system analyzes the input data to “learn” a set of rules (also referred to as the machine learning “model”) that can be used to map the input data to the answers. During the inferencing phase, the machine learning system uses the trained model to infer answers (such as bounding boxes) from new input data.

Deep learning is a particular form of machine learning in which the model being trained is a multi-layer neural network. Deep learning architectures are often referred to as artificial neural networks because of the manner in which information is processed (similar to a biological nervous system). For example, each layer of the deep learning architecture is formed by a number of artificial neurons. The neurons are interconnected across the various layers so that input data may be passed from one layer to another. More specifically, each layer of neurons may perform a different set of transformations on the input data (or the outputs from the previous layer) that ultimately results in a desired inference.

A convolutional neural network (CNN) is a particular type of artificial neural network that processes data in a manner similar to the human visual system. As such, CNNs are well-suited for computer vision applications. Each neuron in a CNN responds to a respective subset of the data from a previous layer, located within its “receptive field,” by outputting an “activation” representing a higher level abstraction of a feature in its receptive field. The receptive fields of the neurons in a given layer are combined to cover the entire input from the previous layer (similar to how the receptive fields of cortical neurons in the brain cover the entire visual field). The set of activations output by each layer is collectively referred to as a “feature map.”

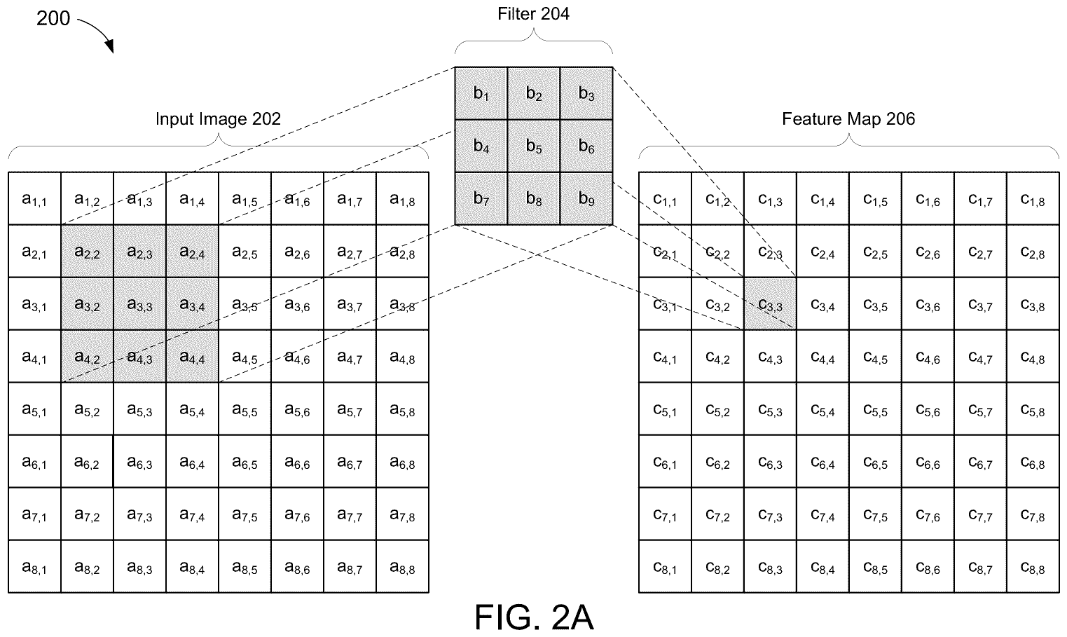

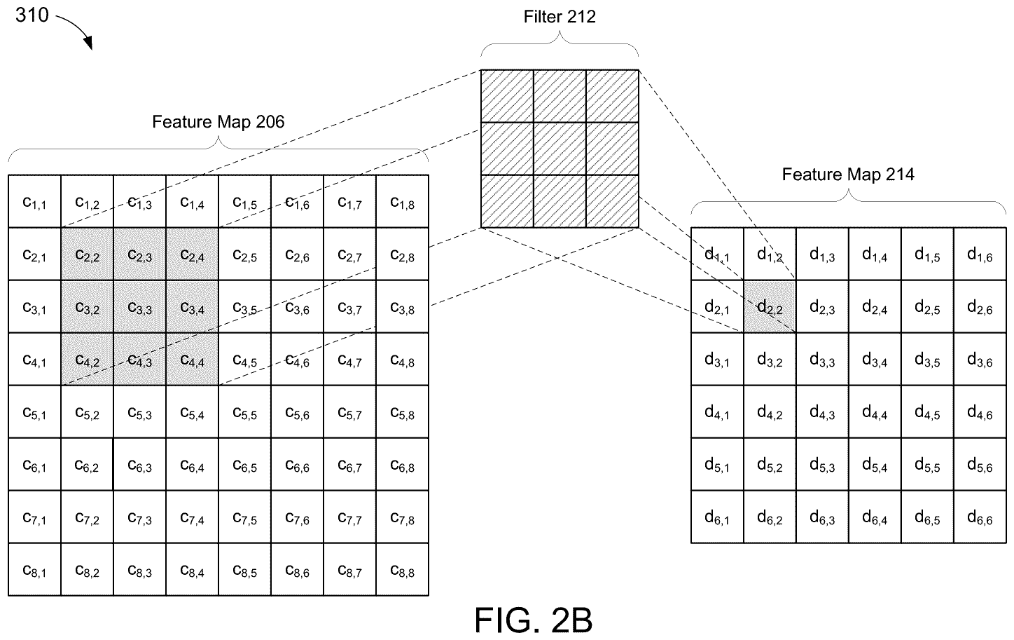

FIG. 2A shows an example neural network operation 200 that can be performed by a CNN. More specifically, the CNN may generate a feature map 206 by applying a filter 204 (also referred to as a “neural network filter”) to the pixel values of an input image 202. With reference for example to FIG. 1, the input image 202 may be one example of the image 102. In some aspects, the filter 204 may be a convolutional filter associated with a convolutional layer of the CNN.

In the example of FIG. 2A, the input image 202 is depicted as an 8×8 array of pixel values a_{1,1}-a_{8,8}, the filter 204 is depicted as a 3×3 matrix having filter weights b₁-b₉, and the feature map 206 is depicted as an 8×8 array of activations c_{1,1}-c_{8,8}. However, in actual implementations, the input image 202, the filter 204, and the feature map 206 may have any suitable dimensions. The feature map 206 is generated by applying the filter 204 to various 3×3 subarrays of pixel values in the input image 202 with a stride of 1 and same padding (which adds zero values to the border of the input image 202 to participate in the convolutions).

For example, as shown by the shaded regions of FIG. 2A, the CNN may apply the filter 204 to the subarray of pixel values a_{2,2}, a_{2,3}, a_{2,4}, a_{3,2}, a_{3,3}, a_{3,4}, a_{4,2}, a_{4,3}, and a_{4,4} to produce the activation c_{3,3} (where c_{3,3}=b₁·a_{2,2}+b₂·a_{2,3}+b₃·a_{2,4}+b₄·a_{3,2}+b₅·a_{3,3}+b₆·a_{3,4}+b₇·a_{4,2}+b₈·a_{4,3}+b₉·a_{4,4}). Thus, the pixel values a_{2,2}, a_{2,3}, a_{2,4}, a_{3,2}, a_{3,3}, a_{3,4}, a_{4,2}, a_{4,3}, and a_{4,4} fall within the receptive field of an artificial neuron that produces the activation c_{3,3}. The remaining activations of the feature map 206 can be produced, in a similar manner, by sliding the filter 204 over the input image 202.

FIG. 2B shows another example neural network operation 210 that can be performed by a CNN. More specifically, the CNN may generate another feature map 214 by applying a filter 212 (also referred to as a “neural network filter”) to the activations of the feature map 206. For example, the feature map 214 may be associated with a deeper layer of the CNN than the feature map 206. In some aspects, the filter 212 may be a pooling filter associated with a pooling layer of the neural network.

In the example of FIG. 2B, the filter 212 is depicted as a 3×3 pooling matrix and feature map 214 is depicted as a 6×6 array of activations d_{1,1}-d_{6,6}. However, in actual implementations, the filter 212 and the feature map 214 may have any suitable dimensions. The feature map 214 may be generated by applying the filter 212 to various 3×3 subarrays of activations in the feature map 206 with a stride of 1 and valid padding (or no padding).

For example, as shown by the shaded regions of FIG. 2B, the neural network may apply the filter 212 to the subarray of activations c_{2,2}, c_{2,3}, c_{2,4}, c_{3,2}, c_{3,3}, c_{3,4}, c_{4,2}, c_{4,3}, and c_{4,4} to produce the activation d_{2,2}. Thus, the pixel values c_{2,2}, c_{2,3}, c_{2,4}, c_{3,2}, c_{3,3}, c_{3,4}, c_{4,2}, c_{4,3}, and c_{4,4} fall within the receptive field of an artificial neuron that produces the activation d_{2,2}. In some aspects, the filter 212 may be configured to perform a max pooling operation (where d_{2,2}=max (c_{2,2}, c_{2,3}, c_{2,4}, c_{3,2}, c_{3,3}, c_{3,4}, c_{4,2}, c_{4,3}, c_{4,4})). In some other aspects, the filter 312 may be configured to perform an average pooling operation (where d_{2,2}=(c_{2,2}+c_{2,3}+c_{2,4}+c_{3,2}+c_{3,3}+c_{3,4}+c_{4,2}+c_{4,3}+c_{4,4})/9). The remaining activations of the feature map 214 can be produced, in a similar manner, by sliding the filter 212 over the feature map 206.

As shown in FIGS. 2A and 2B, CNNs extract features from an input image in a hierarchical manner. For example, neurons associated with lower (or earlier) layers of a CNN can extract smaller features associated with an input image at lower level of abstraction. By contrast, neurons associated with higher (or later) layers of a CNN can extract larger features associated with an input image at higher levels of abstraction. As a result, feature maps produced by lower layers of a CNN tend to have higher spatial resolution but lower semantic value compared to feature maps produced by higher layers of the CNN. Because distant objects appear small in an input image, and have fewer or less pronounced features, such objects are more likely to be detected based on features extracted by the lower layers of a CNN.

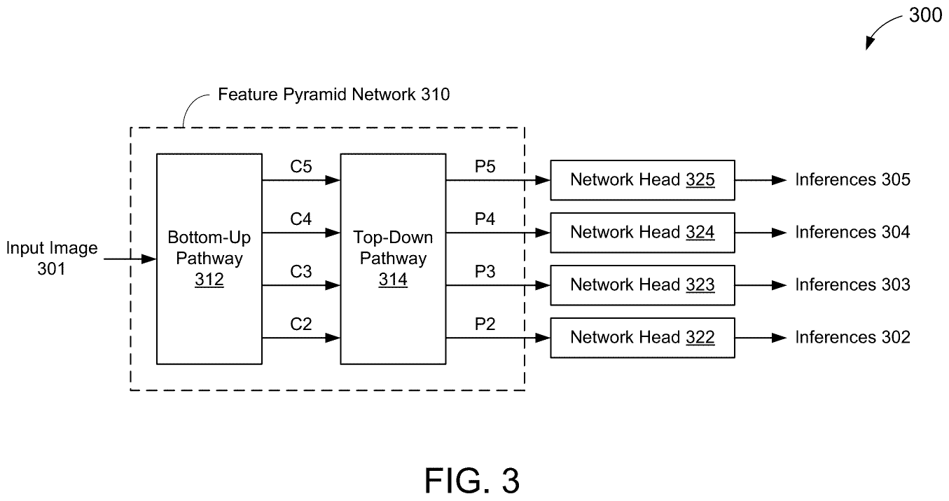

FIG. 3 shows a block diagram of an example object detection network 300 based on a feature pyramid network architecture. The object detection network 300 is configured to receive an input image 301 and produce a number of inferences 302-305 based on the input image 301. In some implementations, the object detection network 300 may be one example of the image analysis component 120 of FIG. 1. With reference for example to FIG. 1, the input image 301 may be one example of the image 102 and the inferences 302-305 may be examples of the inference 103.

The object detection network 300 includes a feature pyramid network (FPN) 310 and a number of network heads 322-325. The FPN 310 is configured to extract a number of feature maps P2-P5 from the input image 301 based, at least in part, on a convolutional neural network (CNN). More specifically, each of the feature maps P2-P5 is associated with a respective “pyramid level” of the FPN 310. In the example of FIG. 3, the FPN 310 is shown to include 4 pyramid levels. In actual implementations, the FPN 310 may include fewer or more pyramid levels than those depicted in FIG. 3. The FPN 310 includes a bottom-up pathway 312 and a top-down pathway 314.

The bottom-up pathway 312 is a feed-forward CNN backbone that produces a number of intermediate feature maps C2-C5 at various network “stages.” A network stage is a collection of layers of the CNN that produce feature maps having the same size or dimension (or number of activations). With reference for example to FIGS. 2A and 2B, the feature maps 206 and 214 are associated with different network stages. Each of the intermediate feature maps C2-C5 represents a feature map output by the last layer of a respective network stage. Accordingly, the bottom-up pathway 312 produces the intermediate feature maps C2-C5 in order of increasing semantic value.

The top-down pathway 314 produces the feature map P5 by applying convolutional filters to the intermediate feature map C5 to reduce its channel depth. The top-down pathway 314 produces the remaining feature maps P2-P4 by progressively upsampling the feature map P5 and combining each upsampled feature map with a respective intermediate feature map from the bottom-up pathway 312. For example, the top-down pathway 314 produces the feature map P4 by upsampling the spatial resolution of the feature map P5 (to match the resolution of the intermediate feature map C4), applying convolutional filters to the intermediate feature map C4, and merging the result of the convolution with the upsampled feature map (via element-wise addition).

The top-down pathway 314 produces the feature map P3 by upsampling the spatial resolution of the feature map P4 (to match the resolution of the intermediate feature map C3), applying convolutional filters to the intermediate feature map C3, and merging the result of the convolution with the upsampled feature map. This process is repeated to produce the feature map P2. Accordingly, the top-down pathway 314 produces the feature maps P2-P5 in order of increasing spatial resolution. In some implementations, an additional (3×3) convolutional filter may be applied to each of the feature maps P2-P5 to reduce the aliasing effect due to upsampling.

In the example of FIG. 3, the FPN 310 does not produce a feature map (such as P1) matching the resolution of the intermediate feature map C1 associated with the first network stage of the bottom-up pathway 312 due to its large memory footprint (and because any objects detected at this stage would be too small to be reliably detected without additional contextual information). In some implementations, the top-down pathway 314 may be omitted from the FPN 310. In such implementations, the FPN 310 may include only the bottom-up pathway 312 and may directly output the intermediate feature maps C2-C5 as the feature maps P2-P5, respectively.

The network heads 322-325 are configured to perform object detection operations on the feature maps P2-P5, respectively. As such, each of the network heads 322-325 is associated with a respective pyramid level of the FPN 310. More specifically, network heads associated with lower pyramid levels (such as the network head 322) may detect objects based on smaller or finer features. By contrast, network heads associated with higher pyramid levels (such as the network head 325) may detect objects based on larger or coarser features.

In some aspects, each of the network heads 322-325 may be configured to infer bounding boxes associated with objects of interest in the input image 301. For example, each network head may detect objects of interest in the input image 301 based on the features or activations in its respective feature map. Each network head may further map a set of boxes to its respective feature map and adjust the boxes to coincide with any objects of interest detected based on the feature map. In some implementations, the set of boxes may include one or more anchor boxes.

In some implementations, each of the network heads 322-325 may include a classification subnetwork and a box regression subnetwork (not shown for simplicity). For example, the classification subnetwork may infer or indicate a probability that an object of interest is detected at each box location and the box regression subnetwork may infer or regress an offset of each box relative to a nearby object of interest (if detected). Thus, the accuracy of the inferences 302-305 may depend on the number of neural network filters implemented by the network heads 322-325, respectively.

Due to their size and limited resolution, distant objects in the input image 301 are more likely to be detected by the network head 322 associated with the second pyramid level of the FPN 310 (also referred to as the P2 network head) than by any of the network heads 323-325 associated with higher pyramid levels. However, the number of filters implemented by the network head 322 is often limited due to memory constraints of the computer vision system and the high spatial resolution of the feature map P2 associated with the second pyramid level. As a result, many existing object detection networks are unable to detect objects beyond a threshold distance from an image capture device (such as the image capture component 110 of FIG. 1).

Aspects of the present disclosure recognize that computer vision systems are often mounted to fixed locations (such as walls, televisions, or computer monitors) where distant objects are confined to a small region of interest (ROI) in the captured images. Thus, in some aspects, the accuracy of distant object detection can be improved, without increasing the memory budget of the object detection system 300, by focusing the network head 322 on the ROI in which distant objects are confined. In some implementations, the ROI may be used to reduce the size (or number of activations) of the feature map P2 to be processed by the network head 322 (or one or more of the feature maps P3-P5 to be processed by the network heads 323-325, respectively). In some other implementations, the ROI may be used to reduce the size (or number of pixels) of the input image 301 to be processed by a backbone CNN that produces the feature map P2 (or one or more of the other feature maps P3-P5).

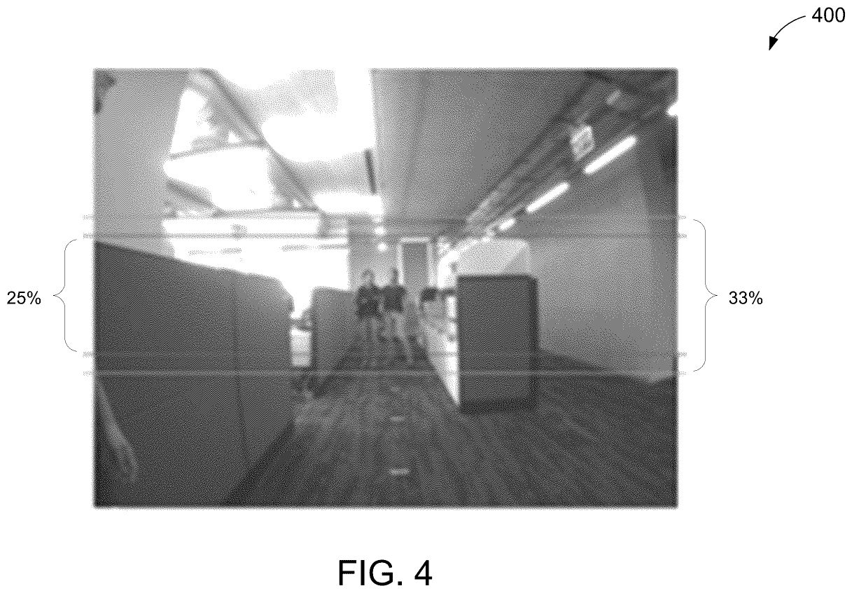

FIG. 4 shows an example image 400 that can be captured by a computer vision system. In some implementations, the computer vision system may be one example of the computer vision system 100 of FIG. 1. With reference for example to FIG. 1, the image 400 may be one example of the image 102 captured by the image capture component 110.

In the example of FIG. 4, the image capture component 110 is mounted to a wall at the end of a hallway and the FOV 112 of the image capture component 110 is centered on a doorway at the opposite end of the hallway. As such, distant objects of interest (representing people) are confined to a narrow ROI in the image 400 between, and parallel to, the floor and the ceiling. More specifically, as shown in FIG. 4, human heads are confined to a horizontal region spanning 25% of the total height of the image 400, whereas full human bodies are confined to a horizontal region spanning 33% of the total height of the image 400. Because the FOV 112 is centered between the floor and the ceiling, the ROI is also centered around the middle of the image 400. However, the position of the ROI relative to the image 400 may vary depending on the positioning of the FOV 112 of the image capture component 110.

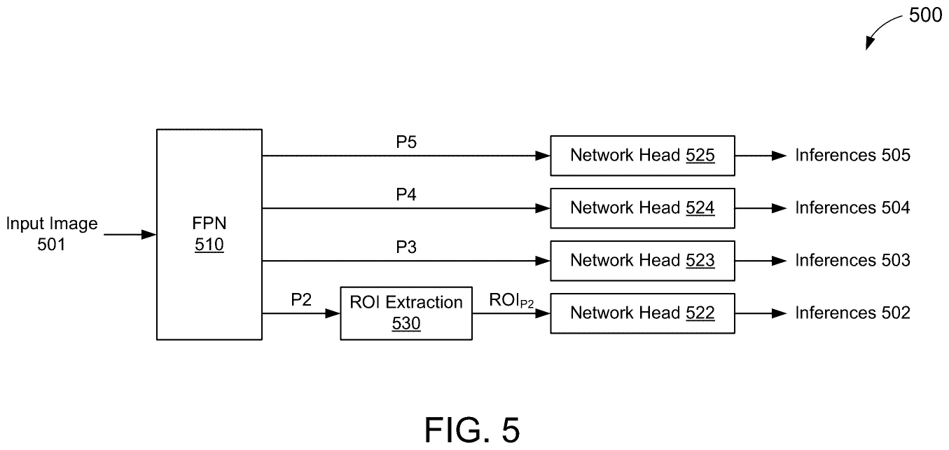

FIG. 5 shows a block diagram of an example object detection network 500, according to some implementations. The object detection network 500 is configured to receive an input image 501 and produce a number of inferences 502-505 based on the input image 501. In some implementations, the object detection network 500 may be one example of the image analysis component 120 of FIG. 1. With reference for example to FIG. 1, the input image 501 may be one example of the image 102 and the inferences 502-505 may be examples of the inference 103.

The object detection network 500 includes an FPN 510, a number of network heads 522-525, and an ROI extraction component 530. The FPN 510 is configured to extract a number of feature maps P2-P5 from the input image 501 based, at least in part, on a CNN. In some implementations, the FPN 510 may be one example of the FPN 310 of FIG. 3. Thus, the FPN 510 may include a bottom-up pathway (such as the bottom-up pathway 312) and a top-down pathway (such as the top-down pathway 314). As described with reference to FIG. 3, each of the feature maps P2-P5 is associated with a respective pyramid level of the FPN 510. In the example of FIG. 5, the FPN 510 is shown to include 4 pyramid levels. In actual implementations, the FPN 510 may include fewer or more pyramid levels than those depicted in FIG. 5.

In the example of FIG. 5, the ROI extraction component 530 is configured to select a region of the feature map P2, associated with the second pyramid level of the FPN 510, for distant object detection. For example, the selected region may coincide with an ROI in which distant objects in the input image 501 are expected to be confined (such as described with reference to FIG. 4). In some aspects, the ROI extraction component 530 may output only the subset of activations (ROI_{P2}) in the feature map P2 that are bounded by the selected region. For example, the subset of activations ROI_{P2} may span a width of the feature map P2. In some implementations, the subset of activations ROI_{P2} may represent ˜25% of all activations in the feature map P2. In some other implementations, the subset of activations ROI_{P2} may represent ˜33% of all activations in the feature map P2.

The network head 522 is configured to perform an object detection operation on the subset of activations ROI_{P2} of the feature map P2 and the network heads 523-325 are configured to perform object detection operations on the feature maps P3-P5, respectively. As such, each of the network heads 522-525 is also associated with a respective pyramid level of the FPN 510. In some aspects, each of the network heads 522-525 may be configured to infer bounding boxes associated with objects of interest in the input image 501 (such as described with reference to FIG. 3). In some implementations, each of the network heads 522-525 may include a classification subnetwork and a box regression subnetwork. For example, the classification subnetwork may infer or indicate a probability that an object of interest is detected at each box location and the box regression subnetwork may infer or regress an offset of each box relative to a nearby object of interest (if detected).

As described with reference to FIG. 3, network heads associated with lower pyramid levels (such as the network head 522) may detect objects based on smaller or finer features. As such, distant objects in the input image 501 are more likely to be detected by the network head 522 than by any of the remaining network heads 523-525. Because the object detection operation performed by the network head 522 is confined to the subset of activations ROI_{P2} (rather than the entire feature map P2), the network head 522 can implement a greater number of neural network filters than the network head 322 of FIG. 3 without causing the object detection network 500 to exceed the memory budget of the object detection network 300. As a result, the object detection network 500 can detect distant objects more accurately than the object detection network 300 given the same memory budget.

In the example of FIG. 5, the ROI extraction component 530 is associated only with the second pyramid level of the FPN 510. In other words, only the size of the feature map P2 is reduced for processing by the network head 522. In some other implementations, the ROI extraction component 530 may be associated with one or more higher pyramid levels of the FPN 510 in lieu of, or in addition to, the second pyramid level. For example, the ROI extraction component 530 can reduce the size of any of the remaining feature maps P3-P5 in the same, or similar, manner as the feature map P2. In such implementations, the number of neural network filters implemented by the remaining network heads 523-525 can also be increased without exceeding the memory budget of the object detection network 500.

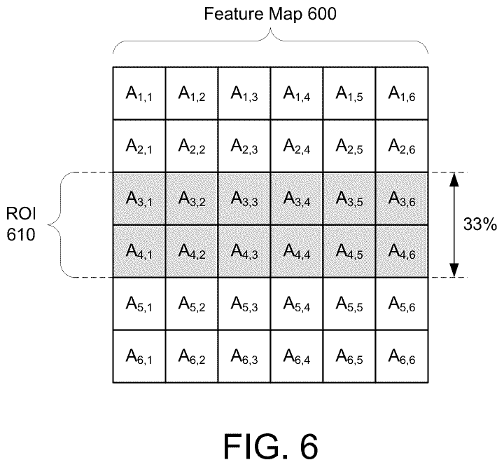

FIG. 6 shows an example ROI 610 that can be extracted from an example feature map 600. In the example of FIG. 6, the feature map 600 is depicted as a 6×6 array of activations A_{1,1}-A_{6,6}. In actual implementations, the feature map 600 may have any suitable dimensions. In some implementations, the feature map 600 may be one example of the feature map P2 of FIG. 5 and the ROI 610 may include the subset of activations ROI_{P2}. In some aspects, the ROI 610 of the feature map 600 may coincide with an ROI of an input image in which distant objects are confined (such as the ROI of the input image 400 of FIG. 4 in which full human bodies are confined).

As shown in FIG. 6, the feature map 600 is subdivided into three horizontal segments (referred to as upper, middle, and lower segments). More specifically, the upper segment includes the top two rows of activations A_{1,1}-A_{1,6} and A_{2,1}-A_{2,6}, the middle segment includes the middle two rows of activations A_{3,1}-A_{3,6} and A_{4,1}-A_{4,6}, and the lower segment includes the bottom two rows of activations A_{5,1}-A_{5,6} and A_{6,1}-A_{6,6}. In the example of FIG. 6, the ROI 610 represents the middle segment, which includes 33% of the total activations in the feature map 600 (shaded in gray). However, the ROI 610 may include fewer or more activations than those depicted in FIG. 6. For example, in some other implementations, the ROI 610 may include 25% of the total activations in the feature map 600. With reference for example to FIG. 5, the object detection operation performed by the network head 522 may be confined to the ROI 610 of the feature map 600. For example, the ROI extraction component 530 may output only the subset of activations A_{3,1}-A_{3,6} and A_{4,1}-A_{4,6} to the network head 522 for distant object detection.

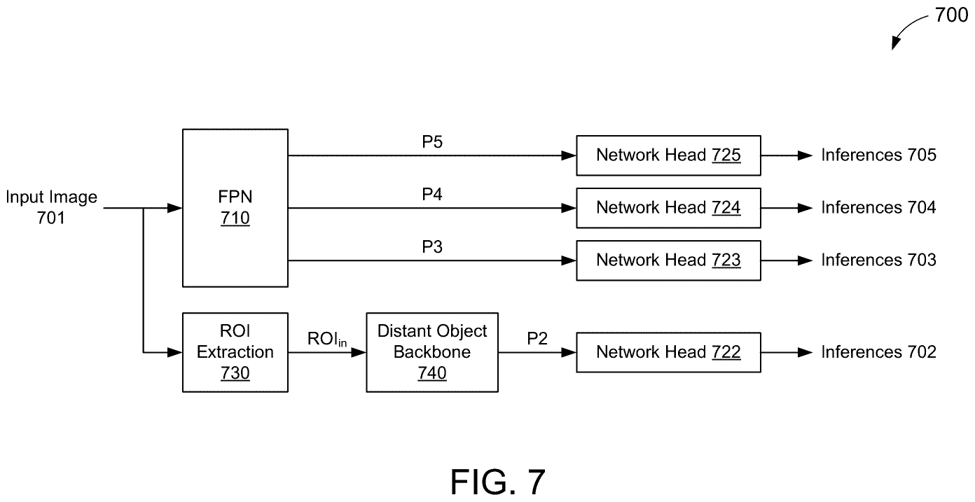

FIG. 7 shows a block diagram of another example object detection network, according to some implementations. The object detection network 700 is configured to receive an input image 701 and produce a number of inferences 702-705 based on the input image 701. In some implementations, the object detection network 700 may be one example of the image analysis component 120 of FIG. 1. With reference for example to FIG. 1, the input image 701 may be one example of the image 102 and the inferences 702-705 may be examples of the inference 103.

The object detection network includes an FPN 710, a number of network heads 722-725, an ROI extraction component 730, and a distant object backbone 740. The FPN 710 is configured to extract a number of feature maps P3-P5 from the input image 701 based, at least in part, on a CNN. In some implementations, the FPN 710 may be one example of the FPN 310 of FIG. 3. Thus, the FPN 710 may include a bottom-up pathway (such as the bottom-up pathway 312) and a top-down pathway (such as the top-down pathway 314). As described with reference to FIG. 3, each of the feature maps P3-P5 is associated with a respective pyramid level of the FPN 710. In the example of FIG. 7, the FPN 710 is shown to include 4 pyramid levels. However, unlike the top-down pathway 314, the top-down pathway of the FPN 710 does not produce a feature map associated with the second pyramid level (such as the feature map P2 output by the FPN 310). In actual implementations, the FPN 710 may include fewer or more pyramid levels than those depicted in FIG. 7.

The ROI extraction component 730 is configured to select a region of the input image 701 for distant object detection. For example, the selected region may be an ROI in which distant objects in the input image 701 are expected to be confined (such as described with reference to FIG. 4). In some aspects, the ROI extraction component 730 may output only the subset of pixel values (ROIᵢₙ) in the input image 701 that are bounded by the selected region. For example, the subset of pixel values ROIᵢₙ may span a width of the input image 701. In some implementations, the subset of pixel values ROIᵢₙ may represent ˜25% of all pixels values in the input image 701. In some other implementations, the subset of pixel values ROIᵢₙ may represent ˜33% of all pixel values in the input image 701.

The distant object backbone 740 is configured to extract a feature map P2, associated with the second pyramid level of the FPN 710, from the subset of pixel values ROIᵢₙ. In some implementations, the distant object backbone 740 may be a feed-forward CNN having two network stages (similar to the first two network stages of the bottom-up pathway of the FPN 710). Because the feature extraction operations performed by the distant object backbone 740 are confined to the subset of pixel values ROIᵢₙ (rather than the entire input image 701), the feature map P2 produced by the distant object backbone 740 may include fewer activations than the feature map P2 produced by the FPN 310 of FIG. 3. As such, the distant object backbone 740 can implement a greater number of neural network filters than the first two network stages of the bottom-up pathway 312 of the FPN 310 without causing the object detection network 700 to exceed the memory budget of the object detection network 300.

The network heads 722-725 are configured to perform object detection operations on the feature maps P2-P5, respectively. As such, each of the network heads 722-725 is also associated with a respective pyramid level of the FPN 710. In some aspects, each of the network heads 722-725 may be configured to infer bounding boxes associated with objects of interest in the input image 701 (such as described with reference to FIG. 3). In some implementations, each of the network heads 722-725 may include a classification subnetwork and a box regression subnetwork. For example, the classification subnetwork may infer or indicate a probability that an object of interest is detected at each box location and the box regression subnetwork may infer or regress an offset of each box relative to a nearby object of interest (if detected).

As described with reference to FIG. 3, network heads associated with lower pyramid levels (such as the network head 722) may detect objects based on smaller or finer features. As such, distant objects in the input image 701 are more likely to be detected by the network head 722 than by any of the remaining network heads 723-725. Because the feature map P2 produced by the distant object backbone 740 is smaller (or has fewer activations) than the feature map P2 produced by the FPN 310 of FIG. 3, the network head 722 can implement the same (or greater) number of neural network filters as the network head 322 without causing the object detection network 700 to exceed the memory budget of the object detection network 300. As a result, the object detection network 700 can detect distant objects more accurately than the object detection network 300 given the same memory budget.

In the example of FIG. 7, the distant object backbone 740 is associated only with the second pyramid level of the FPN 710. In other words, only the size of the feature map P2 is reduced for processing by the network head 722. In some other implementations, the distant object backbone 740 may be associated with one or more higher pyramid levels of the FPN 710 in lieu of, or in addition to, the second pyramid level. For example, the distant object backbone 740 can be used to produce any of the remaining feature maps P3-P5 based on the subset of pixel values ROIᵢₙ in the same, or similar, manner as the feature map P2. In such implementations, the number of neural network filters implemented by the remaining network heads 523-525 can also be increased without exceeding the memory budget of the object detection network 500.

Aspects of the present disclosure further recognize that, in the example of FIG. 7, higher pyramid levels of the FPN 710 can be used only to detect objects of interest that are larger or closer to the image capture device (compared to the objects detected by the network head 722). As such, the number of neural network filters implemented by the FPN 710 can be reduced (compared to the number of neural network filters implemented by the FPN 310) without sacrificing the accuracy with which larger objects are detected. In some implementations, the bottom-up pathway of the FPN 710 may implement fewer neural network filters than the bottom-up pathway 312 of the FPN 310. In such implementations, the distant object backbone 740 can implement even more filters than the first two network stages of the bottom-up pathway 312 without causing the object detection network 700 to exceed the memory budget of the object detection network 300. Such implementations may result in even greater accuracy of distant object detection by the object detection network 700.

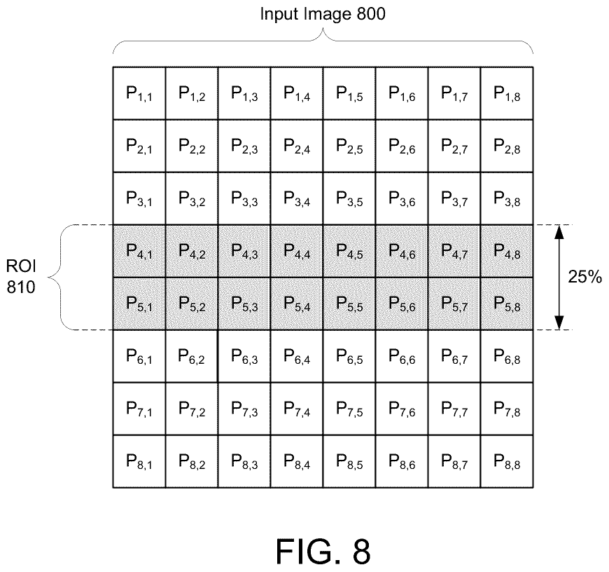

FIG. 8 shows an example ROI 810 that can be extracted from an example input image 800. In the example of FIG. 8, the input image 800 is depicted as an 8×8 array of pixel values P_{1,1}-P_{8,8}. In actual implementations, the input image 800 may have any suitable dimensions. In some implementations, the input image 800 may be one example of the input image 701 of FIG. 7 and the ROI 810 may include the subset of pixel values ROIᵢₙ. In some aspects, the ROI 810 of the input image 800 may be an ROI in which distant objects are confined (such as the ROI of the input image 400 of FIG. 4 in which human heads are confined).

As shown in FIG. 8, the input image 800 is subdivided into three horizontal segments (referred to as upper, middle, and lower segments). More specifically, the upper segment includes the top three rows of pixel values P_{1,1}-P_{1,8}, P_{2,1}-P_{2,8}, and P_{3,1}-P_{3,8}, the middle segment includes the middle two rows of pixel values P_{4,1}-P_{4,8} and P_{5,1}-P_{5,8}, and the lower segment includes the bottom three rows of pixel values P_{6,1}-P_{6,8}, P_{7,1}-P_{7,8}, and P_{8,1}-P_{8,8}. In the example of FIG. 8, the ROI 810 represents the middle segment, which includes 25% of the total activations in the input image 800 (shaded in gray). However, the ROI 810 may include fewer or more pixel values than those depicted in FIG. 8. For example, in some implementations, the ROI 810 may include 33% of the total activations in the input image 800. With reference for example to FIG. 7, the feature extraction operation performed by the distant object backbone 740 may be confined to the ROI 810 of the input image 800. For example, the ROI extraction component 730 may output only the subset of pixel values P_{4,1}-P_{4,8} and P_{5,1}-P_{5,8} to the object detection model 740 for feature extraction.

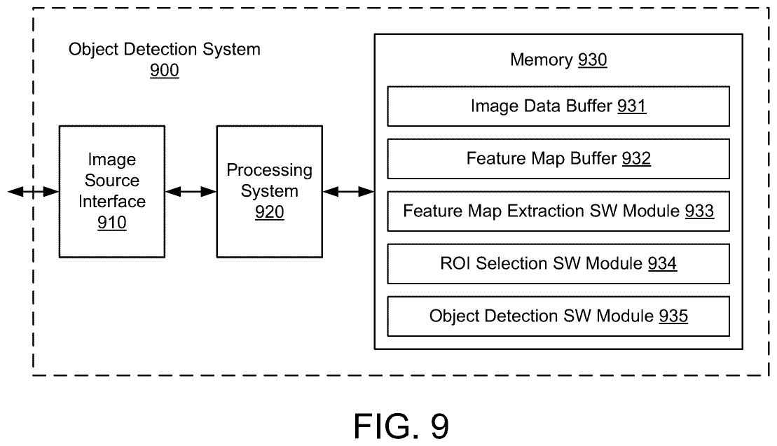

FIG. 9 shows a block diagram of an example object detection system 900, according to some implementations. In some implementations, the object detection system 900 may be one example of the image analysis component 120 of FIG. 1 or the object detection network 500 of FIG. 5. More specifically, the object detection system 900 may be configured to infer a presence or locations of objects of interest in images (or video).

The object detection system 900 includes an image source interface 910, a processing system 920, and a memory 930. The image source interface 910 is configured to receive an input image from an image source (such as the image capture component 110 of FIG. 1). The memory 930 may include an image data buffer 931 to store the received input image and a feature map buffer 932 to store one or more feature maps produced by the object detection system 900 as a result of generating the inferences.

The memory 930 also may include a non-transitory computer-readable medium (including one or more nonvolatile memory elements, such as EPROM, EEPROM, Flash memory, a hard drive, and the like) that may store at least the following software (SW) modules:
a feature map extraction SW module 933 to extract a plurality of feature maps from the input image based on an FPN having a plurality of pyramid levels, where each feature map of the plurality of feature maps is associated with a respective pyramid level of the plurality of pyramid levels;
an ROI selection SW module 934 to select a region of a first feature map of the plurality of feature maps for distant object detection; and
an object detection SW module 935 to perform an object detection operation on each feature map of the plurality of feature maps based on a respective network head so that the object detection operation performed on the first feature map is confined to the selected region.
   Each software module includes instructions that, when executed by the processing system 920, causes the object detection system 900 to perform the corresponding functions.

The processing system 920 may include any suitable one or more processors capable of executing scripts or instructions of one or more software programs stored in the object detection system 900 (such as in memory 930). For example, the processing system 920 may execute the feature map extraction SW module 933 to extract a plurality of feature maps from the input image based on an FPN having a plurality of pyramid levels, where each feature map of the plurality of feature maps is associated with a respective pyramid level of the plurality of pyramid levels. The processing system 920 also may execute the ROI selection SW module 934 to select a region of a first feature map of the plurality of feature maps for distant object detection. The processing system 920 may further execute the object detection SW module 935 to perform an object detection operation on each feature map of the plurality of feature maps based on a respective network head so that the object detection operation performed on the first feature map is confined to the selected region.

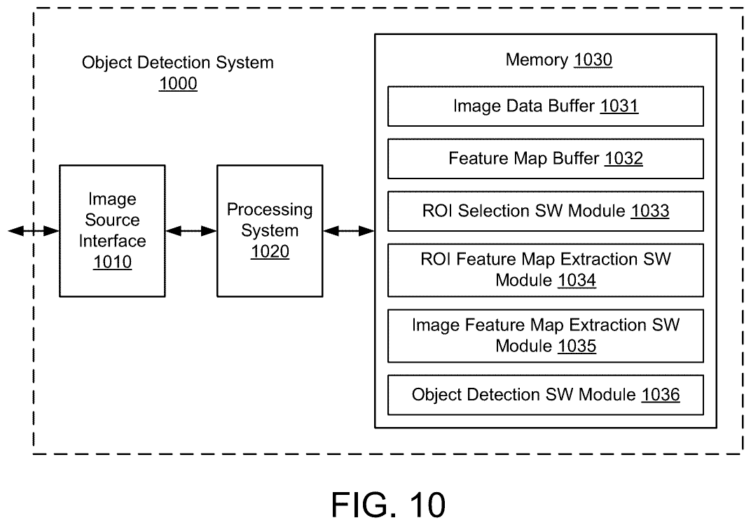

FIG. 10 shows a block diagram of another example object detection system 1000, according to some implementations. In some implementations, the object detection system 1000 may be one example of the image analysis component 120 of FIG. 1 or the object detection network 700 of FIG. 7. More specifically, the object detection system 1000 may be configured to infer a presence or locations of objects of interest in images (or video).

The object detection system 1000 includes an image source interface 1010, a processing system 1020, and a memory 1030. The image source interface 1010 is configured to receive an input image from an image source (such as the image capture component 110 of FIG. 1). The memory 1030 may include an image data buffer 1031 to store the received input image and a feature map buffer 1032 to store one or more feature maps produced by the object detection system 1000 as a result of generating the inferences.

The memory 1030 also may include a non-transitory computer-readable medium (including one or more nonvolatile memory elements, such as EPROM, EEPROM, Flash memory, a hard drive, and the like) that may store at least the following software (SW) modules:
an ROI selection SW module 1033 to select a region of the input image for distant object detection;
an ROI feature map extraction SW module 1034 to extract, from the selected region of the input image, a first feature map of a plurality of feature maps based on a backbone CNN;
an image feature map extraction SW module 1035 to extract, from the input image, one or more second feature maps of the plurality of feature maps based on an FPN having a plurality of pyramid levels, where each feature map of the plurality of feature maps is associated with a respective pyramid level of the plurality of pyramid levels; and
an object detection SW module 1036 to perform an object detection operation on each feature map of the plurality of feature maps based on a respective network head.

Each software module includes instructions that, when executed by the processing system 1020, causes the object detection system 1000 to perform the corresponding functions.

The processing system 1020 may include any suitable one or more processors capable of executing scripts or instructions of one or more software programs stored in the object detection system 1000 (such as in memory 1030). For example, the processing system 1020 may execute the ROI selection SW module 1033 to select a region of the input image for distant object detection. The processing system 1020 may further execute the ROI feature map extraction SW module 1034 to extract, from the selected region of the input image, a first feature map of a plurality of feature maps based on a backbone CNN. The processing system 1020 may execute the image feature map extraction SW module 1035 to extract, from the input image, one or more second feature maps of the plurality of feature maps based on an FPN having a plurality of pyramid levels, where each feature map of the plurality of feature maps is associated with a respective pyramid level of the plurality of pyramid levels. The processing system 1020 may further execute the object detection SW module 1036 to perform an object detection operation on each feature map of the plurality of feature maps based on a respective network head.

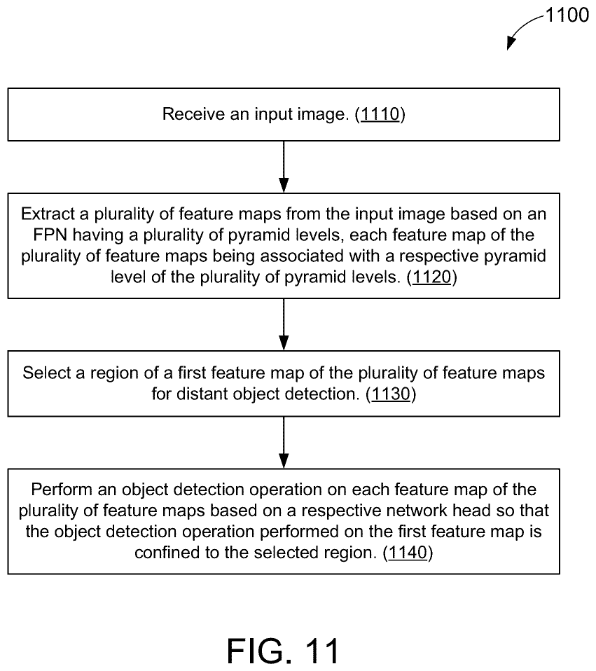

FIG. 11 shows an illustrative flowchart depicting an example object detection operation 1100, according to some implementations. In some implementations, the example operation 1100 may be performed by an object detection system (such as the image analysis component 120 of FIG. 1 or the object detection network 500 of FIG. 5) to infer a presence or locations of objects of interest in images (or video).

The object detection system receives an input image (1110). The object detection system extracts a plurality of feature maps from the input image based on an FPN having a plurality of pyramid levels, where each feature map of the plurality of feature maps is associated with a respective pyramid level of the plurality of pyramid levels (1120). The object detection system selects a region of a first feature map of the plurality of feature maps for distant object detection (1130). The object detection system performs an object detection operation on each feature map of the plurality of feature maps based on a respective network head so that the object detection operation performed on the first feature map is confined to the selected region (1140).

In some implementations, the FPN may include a bottom-up pathway that produces the plurality of feature maps, based on the input image, in order of increasing semantic value. In some other implementations, the FPN may include a bottom-up pathway that produces a plurality of intermediate feature maps, based on the input image, in order of increasing semantic value and a top-down pathway that produces the plurality of feature maps, based on the plurality of intermediate feature maps, in order of increasing spatial resolution.

In some implementations, the first feature map may be associated with the lowest pyramid level of the plurality of pyramid levels. In some aspects, first feature map may be horizontally subdivided into three non-overlapping segments and the selected region of the first feature map may represent the middle segment of the three segments. In some implementations, the selected region may intersect the center of the first feature map. In some implementations, the selected region may include 25%, or less, of the first feature map.

In some implementations, each of the network heads may include a classification subnetwork and a box regression subnetwork, where the classification subnetwork indicates a probability that an object is detected in each of a plurality of boxes mapped to the respective feature map and the box regression subnetwork regresses a respective offset of each of the plurality of boxes relative to the object.

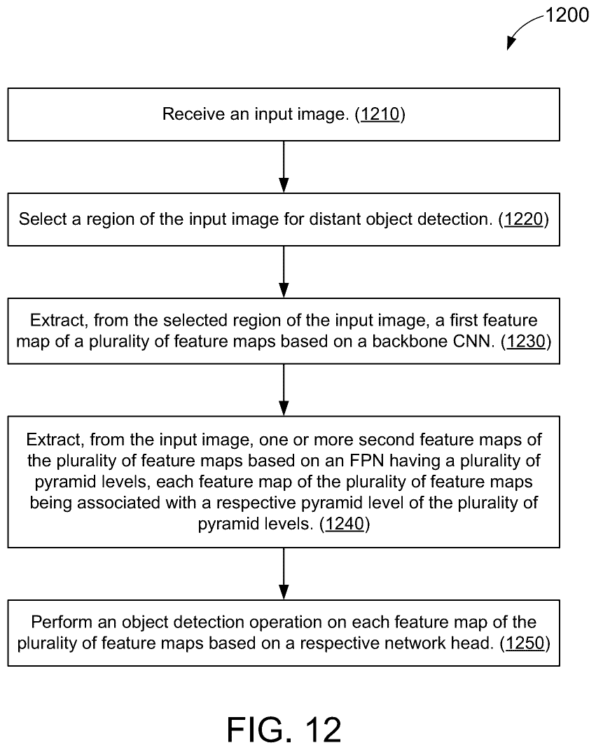

FIG. 12 shows an illustrative flowchart depicting another example object detection operation, according to some implementations. In some implementations, the example operation 1200 may be performed by an object detection system (such as the image analysis component 120 of FIG. 1 or the object detection network 700 of FIG. 7) to infer a presence or locations of objects of interest in images (or video).

The object detection system receives an input image (1210). The object detection system selects a region of the input image for distant object detection (1220). The object detection system extracts, from the selected region of the input image, a first feature map of a plurality of feature maps based on a backbone CNN (1230). The object detection system also extracts, from the input image, one or more second feature maps of the plurality of feature maps based on an FPN having a plurality of pyramid levels, where each feature map of the plurality of feature maps is associated with a respective pyramid level of the plurality of pyramid levels (1240). The object detection network further performs an object detection operation on each feature map of the plurality of feature maps based on a respective network head (1250).

In some implementations, the FPN may include a bottom-up pathway that produces the plurality of feature maps, based on the input image, in order of increasing semantic value. In some other implementations, the FPN may include a bottom-up pathway that produces a plurality of intermediate feature maps, based on the input image, in order of increasing semantic value and a top-down pathway that produces the plurality of feature maps, based on the plurality of intermediate feature maps, in order of increasing spatial resolution. In some implementations, each stage of the backbone CNN may have a greater number of neural network filters than a respective stage of the bottom-up pathway associated with the same pyramid level of the FPN.

In some implementations, the first feature map may be associated with the lowest pyramid level of the plurality of pyramid levels. In some aspects, the input image may be horizontally subdivided into three non-overlapping segments and the selected region of the input image may represent the middle of the three segments. In some implementations, the selected region may intersect the center of the input image. In some implementations, the selected region may include 25%, or less, of the input image.

In some implementations, each of the network heads may include a classification subnetwork and a box regression subnetwork, where the classification subnetwork indicates a probability that an object is detected in each of a plurality of boxes mapped to the respective feature map and the box regression subnetwork regresses a respective offset of each of the plurality of boxes relative to the object.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of object detection, comprising:
receiving an input image;
extracting a plurality of feature maps from the input image based on a feature pyramid network (FPN) having a plurality of pyramid levels, each feature map of the plurality of feature maps being associated with a respective pyramid level of the plurality of pyramid levels;
selecting a region of a first feature map of the plurality of feature maps for distant object detection; and
performing an object detection operation on each feature map of the plurality of feature maps based on a respective network head so that the object detection operation performed on the first feature map is confined to the selected region.

2. The method of claim 1, wherein the FPN comprises a bottom-up pathway that produces the plurality of feature maps, based on the input image, in order of increasing semantic value.

3. The method of claim 1, wherein the FPN comprises a bottom-up pathway that produces a plurality of intermediate feature maps, based on the input image, in order of increasing semantic value and a top-down pathway that produces the plurality of feature maps, based on the plurality of intermediate feature maps, in order of increasing spatial resolution.

4. The method of claim 1, wherein the first feature map is associated with the lowest pyramid level of the plurality of pyramid levels.

5. The method of claim 1, wherein the first feature map is horizontally subdivided into three non-overlapping segments and the selected region of the first feature map represents the middle segment of the three segments.

6. The method of claim 5, wherein the selected region intersects the center of the first feature map.

7. The method of claim 5, wherein the selected region comprises 25%, or less, of the first feature map.

8. The method of claim 1, wherein each of the network heads comprises a classification subnetwork and a box regression subnetwork, the classification subnetwork indicating a probability that an object is detected in each of a plurality of boxes mapped to the respective feature map and the box regression subnetwork regressing a respective offset of each of the plurality of boxes relative to the object.

9. A method of object detection, comprising:
receiving an input image;
selecting a region of the input image for distant object detection;
extracting, from the selected region of the input image, a first feature map of a plurality of feature maps based on a backbone convolutional neural network (CNN);
extracting, from the input image, one or more second feature maps of the plurality of feature maps based on a feature pyramid network (FPN) having a plurality of pyramid levels, each feature map of the plurality of feature maps being associated with a respective pyramid level of the plurality of pyramid levels; and
performing an object detection operation on each feature map of the plurality of feature maps based on a respective network head.

10. The method of claim 9, wherein the FPN comprises a bottom-up pathway that produces the plurality of feature maps, based on the input image, in order of increasing semantic value.

11. The method of claim 9, wherein the FPN comprises a bottom-up pathway that produces a plurality of intermediate feature maps, based on the input image, in order of increasing semantic value and a top-down pathway that produces the one or more second feature maps, based on the plurality of intermediate feature maps, in order of increasing spatial resolution.

12. The method of claim 11, wherein each stage of the backbone CNN has a greater number of neural network filters than a respective stage of the bottom-up pathway associated with the same pyramid level of the FPN.

13. The method of claim 9, wherein the first feature map is associated with the lowest pyramid level of the plurality of pyramid levels.

14. The method of claim 9, wherein the input image is horizontally subdivided into three non-overlapping segments and the selected region of the input image represents the middle segment of the three segments.

15. The method of claim 14, wherein the selected region intersects the center of the input image.

16. The method of claim 14, wherein the selected region comprises 25%, or less, of the input image.

17. The method of claim 9, wherein each of the network heads comprises a classification subnetwork and a box regression subnetwork, the classification subnetwork indicating a probability that an object is detected in each of a plurality of boxes mapped to the respective feature map and the box regression subnetwork regressing a respective offset of each of the plurality of boxes relative to the object.

18. An object detection system comprising:
a processing system; and
a memory storing instructions that, when executed by the processing system, causes the object detection system to:
receive an input image;
select a region of the input image for distant object detection;
extract, from the selected region of the input image, a first feature map of a plurality of feature maps based on a backbone convolutional neural network (CNN);
extract, from the input image, one or more second feature maps of the plurality of feature maps based on a feature pyramid network (FPN) having a plurality of pyramid levels, each feature map of the plurality of feature maps being associated with a respective pyramid level of the plurality of pyramid levels; and
perform an object detection operation on each feature map of the plurality of feature maps based on a respective network head.

19. The object detection system of claim 18, wherein the first feature map is associated with the lowest pyramid level of the plurality of pyramid levels.

20. The object detection system of claim 19, wherein each stage of the backbone CNN has a greater number of neural network filters than a respective stage of the bottom-up pathway associated with the same pyramid level of the FPN.
